(19) United States
(12) Patent Application Publication
(10) Pub. No.: US 2026/0037337 A1
(43) Pub. Date: Feb. 5, 2026

(54) CORE DISTRIBUTION OPTIMIZER FOR MULTI-CORE CPU

(71) Applicant: ORACLE INTERNATIONAL CORPORATION, Redwood Shores, CA (US)

(72) Inventors: Muthu Kumar SATHIYANESAN, North Billerica, MA (US); Benjamin J. FULLER, Concord, MA (US)

(21) Appl. No.: 18/791,571

(22) Filed: Aug. 1, 2024

(51) Int. Cl. G06F 9/50

(52) U.S. Cl. CPC G06F 9/5083; G06F 9/505

(57) ABSTRACT

Systems, methods, and other embodiments associated with distributing cores in a multi-core and/or multi-die CPU are described. In one embodiment, a core distribution system is configured to determine a physical arrangement of a plurality of cores in one or more core clusters of a CPU including rows and columns of cores. Enabled cores and disabled cores are identified within the physical arrangement. A number of target cores to be disabled from the physical arrangement are identified by selecting the target cores to create a uniform physical distribution of disabled cores and enabled cores throughout the physical arrangement of the enabled cores and the disabled cores. The system then disables the identified target cores.

### BACKGROUND

In modern CPU architecture, a processor may include multiple silicon dies, each containing multiple processing cores. A die is a small block of semiconducting material on which a given functional circuit is fabricated. When multiple dies are packaged together in a single processor, it is referred to as a multi-die or chiplet architecture. Each die contains several cores, which are the individual processing units capable of executing instructions independently.

One common physical layout used with compute dies is to organize the cores into a mesh (or grid) configuration. A mesh layout is used to optimize space, power distribution, and inter-core communication. The mesh configuration allows for an efficient design in terms of both physical layout and electrical connections.

During manufacturing, some cores may be identified as defective. The manufacturer typically fuse disables the defective cores, which permanently disables the defective cores. This ensures that the fused cores can never be enabled/activated to control which cores are functional and allow the rest of the chip to function normally.

Many common implementations provide an interface through which a specific core(s) within the mesh can be dynamically enabled or disabled. The UEFI/BIOS (Unified Extensible Firmware Interface/Basic Input/Output System) of a computer system can provide a setup option that enables customers to control the number of cores to activate in a server system's CPU. A user typically reduces the number of cores activated in the CPU to reduce power consumption or for other reasons. In many common BIOS implementations, CPU cores are deactivated in a sequential top-down fashion, starting with the highest core ID numbers.

This can result in an imbalanced distribution of cores across the CPU dies and across the mesh fabric, potentially limiting overall CPU performance and creating other technical problems. For example, an imbalanced distribution of cores can result in overloading interconnect resources in some portions of the mesh while interconnect utilization in other portions of the mesh remains low. Sequentially disabling cores can also cause certain areas of the CPU to become hotspots while others remain cool, leading to thermal imbalance and potential thermal throttling. An improved technique to disable and distribute cores may be beneficial to processing units and computing systems.

### SUMMARY

In one embodiment, a computing system is described with a non-transitory computer-readable medium including stored thereon computer-executable instructions that when executed by at least a processor of the computing system, wherein the computing system includes one or more computing devices, cause the computing system to perform core distribution operations including: receive a request to disable a number of cores in a processing unit, wherein the processing unit includes a physical arrangement of one or more core clusters, wherein each core cluster includes a plurality of cores; determine the physical arrangement of the plurality of cores including rows and columns of cores; determine an association of each core within the plurality of cores to a specific core cluster; identify enabled cores and disabled cores within the physical arrangement; identify a number of target cores to disable from the physical arrangement by selecting the target cores to create a uniform distribution of enabled and disabled cores across of the one or more core clusters; and disable the identified target cores.

In one embodiment, the core distribution operations are configured to distribute cores in two different dimensions. One dimension is across the core clusters and the second dimension is the physical layout of the cores (e.g., across the mesh rows and columns of cores).

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a multi-die CPU with an associated core distribution system.

FIG. 2 illustrates an embodiment of core map for a multi-die CPU with the core distribution system.

FIG. 3 illustrates another embodiment of core map including fused disabled cores associated with performing a core distribution algorithm.

FIG. 4 illustrates one embodiment of a method associated with distributing disabled cores and enabled cores.

FIG. 5 illustrates another embodiment of a method associated with distributing disabled cores and enabled cores.

FIG. 6 illustrates one embodiment of core map after a first and second iteration of the method of FIG. 5.

FIG. 7 illustrates one embodiment of a final core map of FIG. 6 upon completion of the core distribution algorithm.

FIG. 8 illustrates one embodiment of a core map of a CPU with an irregular mesh topology and conversion to a CPU with a regular mesh topology.

FIG. 9 illustrates one embodiment of an initial core map for performing the core distribution algorithm based on the irregular mesh topology (out-of-shape CPU) of FIG. 8.

FIG. 10 illustrates one embodiment of core map after one iteration and the final iteration of distributing disabled cores.

FIG. 11 illustrates an embodiment of a computing system configured with the example systems and/or methods disclosed.

### DETAILED DESCRIPTION

Systems and methods are described herein that optimize distribution of cores in a multi-core CPU or a multi-die CPU. In one embodiment, a core distribution optimizer implements a novel technique and algorithm for distributing cores across core clusters (e.g., across dies) in a more even and balanced manner that considers physical locations and arrangement between enabled cores and disabled cores. For example, the core distribution optimizer executes during a downcoring operation that disables one or more cores on a single die, multi-core CPU or multi-die CPU.

The present system and method address the issue of imbalanced cores in a CPU and aims to enhance overall CPU performance. In one embodiment, the optimized distribution of enabled and disabled cores improves the performance of cache-bound transactions associated with the cores and improves overall signal traffic with a balanced arrangement of cores. The present technique ensures a more equitable distribution of processing power and fosters optimal utilization of a CPU's capabilities, which improves upon the prior core distribution techniques and core arrangements.

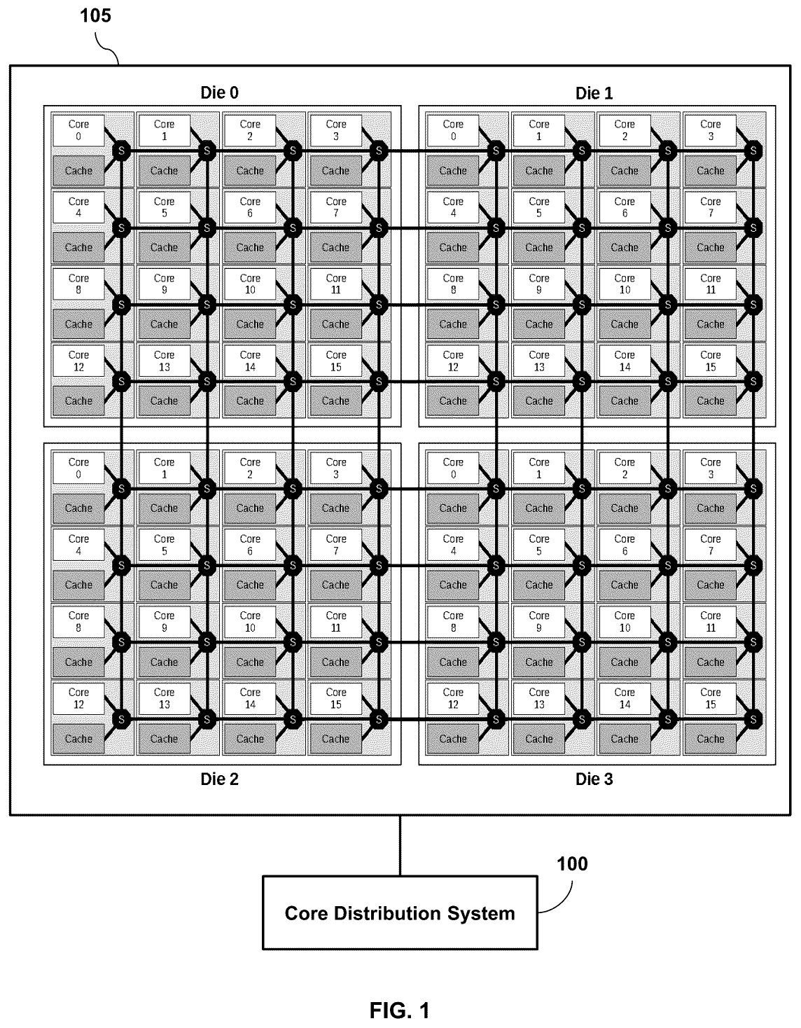

With reference to FIG. 1, one embodiment of a core distribution system 100 is illustrated that is associated with distributing cores in an optimized manner based on, for example, current locations of enabled and disabled cores in a multi-core CPU or a multi-die CPU of a computing system. In general, a “cluster” or “core cluster” is a group of cores that are configured to share resources in the CPU (e.g., share memory, interconnects, etc.). For example, a cluster may include multiple cores which can be physically manifested as separate dies. When referring to a “die” herein, it is intended to include embodiments of a core cluster and vice versa. A core cluster typically includes one die but may include multiple dies in different configurations. The core distribution system 100 may be part of and/or operate with a UEFI/BIOS (Unified Extensible Firmware Interface/Basic Input/Output System) of a computer system to disable and enable cores in a CPU upon a user request and/or upon a defined trigger condition. In another embodiment, the core distribution system 100 may be part of and/or operate with an operating system of a computing system.

For example, a central processing unit CPU 105 is illustrated as a multi-die CPU. CPU 105 includes, but is not limited to, four (4) dies labeled die 0, die 1, die 2, and die 3. In general, a die refers to a single, continuous piece of semiconductor material, typically silicon, that contains one or more cores, along with cache memory, control units, and interfaces for connecting to other parts of the system.

In the example CPU 105, each die includes multiple cores (e.g., grouped as a core cluster), for example, sixteen (16) cores labeled core 0 to core 15. Different numbering schemes or core IDs may be used to identify the cores. For example, the cores in CPU 105 may be numbered 000 to 063 so that each core has a unique ID. In the illustrated example, each die has a physical arrangement of cores that is a 4×4 matrix, and the overall arrangement of the CPU is an 8×8 matrix. Of course, a CPU and/or each die may have different amounts of rows and columns of cores. Typical commercial CPUs may have between 64 to 256 cores, while others may have tens of thousands of cores. In another embodiment, the CPU may have multi-layers of cores that form a 3-Dimensional matrix of cores.

A core map may be used to define or represent the physical arrangement/locations of the cores and identify a current state of each core such as enabled or disabled. Disabled states may further be identified as disabled by software (which is reversible), fused disabled by CPU design/architecture to create different CPU product tiers (which is irreversible), or fused disabled during CPU manufacturing to eliminate defective cores (which is irreversible). The core map may use different numbering schemes and/or labels to identify the current state of a core. Examples are provided below.

With continued reference to FIG. 1, in one embodiment, each core may include an associated cache. Nodes labeled “S” represent switch logic used to interconnect the components within a mesh. In general, a mesh interconnect is a type of network topology used to connect the various cores within a CPU, or across multiple dies in a multi-die CPU. In a mesh topology, each core or die can communicate directly with several neighboring cores or dies, creating a grid-like pattern that maps efficiently to a physical layout.

In general, a CPU has a total number of cores physically present that are created during manufacturing. In any point in time, a current state of the CPU includes a number of enabled/active cores and a number of disabled/non-active cores (e.g., zero or more). One or more cores may be disabled for different reasons. For example, cores may be permanently disabled by fusing during manufacturing when the cores are determined to be defective or to create different product tiers. Cores may be temporarily disabled by BIOS or UEFI settings, which allows the cores to be re-enabled when desired.

As an overview, for example in a downcoring operation, the core distribution system 100 may receive a request via UEFI/BIOS to disable X number of cores. For example, a user may select via a user interface how many cores to disable or enable. The request may identify a total number of cores to enable, which results in disabling X number of cores when the requested number is less than the current number of enabled cores. The core distribution system 100 may be configured to identify, select, and disable the X number of cores based on at least a physical arrangement of enabled and disabled cores to create a balanced distribution of enabled and disabled cores throughout the physical arrangement of the multi-core CPU. For example, a balanced distribution attempts to create a uniform distribution of enabled cores and/or disabled cores.

In one embodiment, the balanced distribution considers the physical locations of currently enabled cores relative to each other and to currently disabled cores that may exist when selecting the next core to disable. For example, the core distribution system 100 may be configured to identify an area in the mesh architecture that includes the greatest number of enabled/active cores (e.g., area with the most heavily utilized cores in the CPU). One enabled core in this area is then selected to be disabled. Upon disabling a core, the current state of the physical arrangement of enabled and disabled cores is changed and impacted.

The core distribution system 100 then repeats the process to select the next core to disable based on the current locations of enable and disabled cores. In general, the core distribution system 100 may include and execute an algorithm that uniformly distributes the selected cores to disable throughout the physical architecture based on physical locations of currently enabled cores and currently disabled cores.

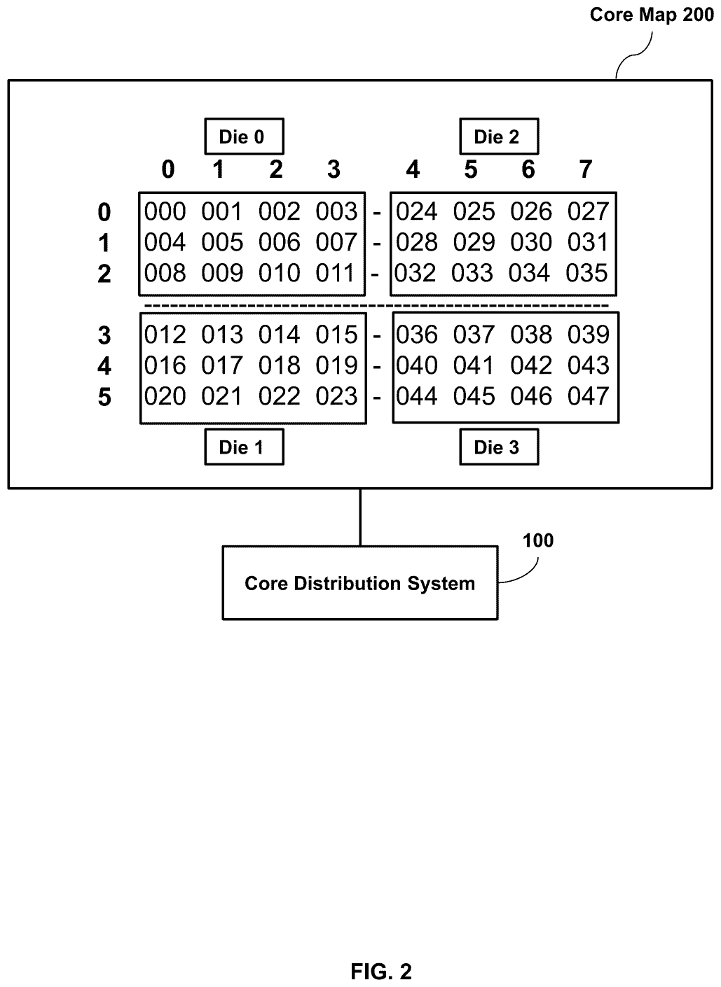

With reference to FIG. 2, one embodiment of an example core map 200 is illustrated that identifies each core in a multi-core and/or multi-die CPU. In the example, the core map 200 includes four dies labeled Die 0, Die 1, Die 2, and Die 3. As mentioned previously, each die represents a core cluster such that there are four core clusters. Each die includes twelve cores identified by three digit core ID numbers 000, 001, 002, etc. The processing unit thus includes a total of forty eight cores (e.g., cores 000 to 047). The core map 200 represents a physical layout and configuration of the dies and the physical locations of the cores on each die relative to each other. In general, the dies and the cores are arranged in a matrix configuration with rows and columns of cores.

The example core map 200 shows a 6 row x 8 column matrix of cores. To assist in the following examples, the matrix in the core map 200 is labeled in FIG. 2 with rows 0 to 5 and columns 0 to 7. Thus, core ID 017 is found in row 4, column 1. The core map 200 and the physical arrangement of cores may be used by the core distribution system 100 to determine and identify which specific cores to disable upon a request to disable a number of cores.

As referred to herein, core map 200 shows that the CPU has a “regular shape” or “in-shape” configuration of cores (e.g., a regular mesh topology). In general, this means the CPU has a core in each (row, column) location in the overall mesh/matrix. When a die in the CPU has one or more cores that are missing in the mesh topology, then the core clusters/dies and/or the CPU have an incomplete matrix of cores or irregular mesh topology of cores, which is referred to as an “out-of-shape” configuration of cores. For example, one or more cores may be missing in the matrix because the cores were intentionally not included for a particular CPU design. In one embodiment, the core distribution system 100 may be configured to perform a core disabling operation in a different manner for an out-of-shape CPU than an in-shape CPU. This will be described below in other embodiments.

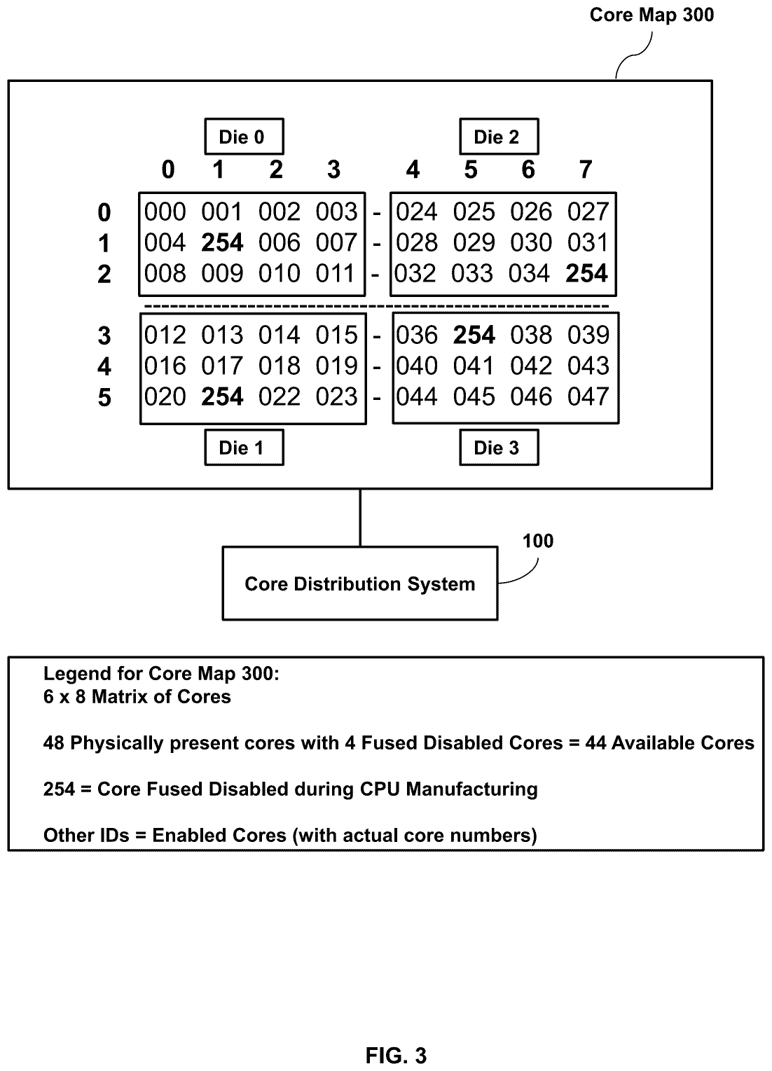

With reference to FIG. 3, another example of a core map 300 is illustrated for a CPU. Core map 300 has a similar 6×8 matrix of cores as core map 200. However, core map 300 includes four cores that were fused-off (fused disabled) during manufacturing of the CPU. These cores have core IDs 005, 021, 035, and 037 in the core map 300. The fused disabled cores are labeled with the ID “254” to represent a fused disabled status (e.g., fused during CPU manufacturing). Thus, this CPU has a total of 44 available cores. Since the core matrix has a core in all (row, column) locations, the CPU is regarded as an in-shape or regular shape CPU.

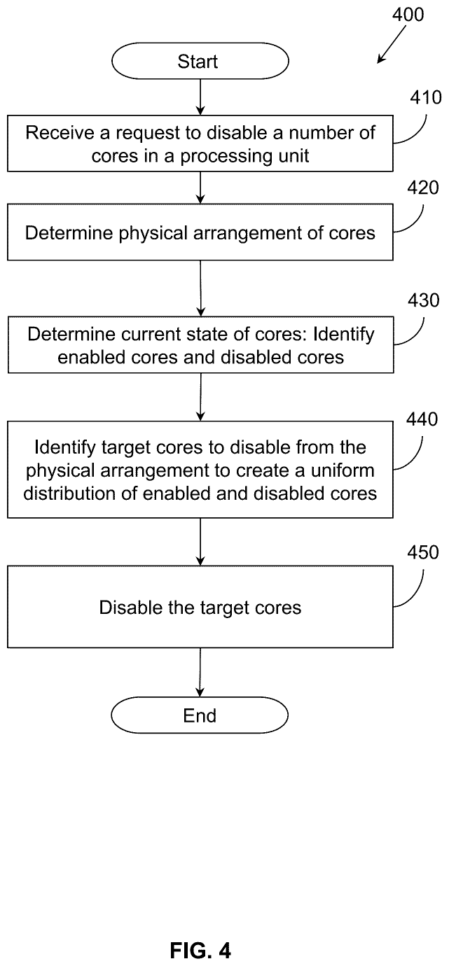

Core map 300 will be used to describe a core disabling and distribution method in FIG. 4 that is performed by the core distribution system 100, in one embodiment. In this example, the core distribution system 100 receives a request to disable a certain number of cores, for example, disable eight (8) cores in the CPU. Similarly, the request may represent a total number of desired enabled cores (e.g., a request to have 36 enabled cores). This may be converted to a number of cores to disable (e.g., 44 total available cores-36 enabled=8 cores to be disabled). Upon completion of the disabling process, the CPU will have 36 enabled cores and 8 disabled cores. The 8 disabled cores will be in addition to the 4 fused disabled cores that are not counted in the total available cores.

### Distributing Disabled Cores First Embodiment

With reference to FIG. 4, one embodiment of a core disabling and distribution method 400 is shown that may be performed by the core distribution system 100. The core disabling and distribution method 400 considers the current state of the physical arrangement/locations of enable cores and disabled cores in the CPU when deciding which cores to disable.

At block 410, a request is received to disable a number of cores in the processing unit, for example, via the UEFI/BIOS of a computing system. The processing unit may include a physical arrangement of one or more core clusters, wherein each core cluster includes a plurality of cores. In general, a cluster includes a group of cores that share resources in the processing unit. The processing unit may include one or more dies and each die may comprise a physical arrangement of a plurality of cores. In one example, a core cluster may be defined to include one die or multiple dies. The request triggers the core distribution system 100 to execute a core distribution algorithm (described in the following steps) that determines which cores to disable in an optimized manner to provide an optimized distribution of enabled and disabled cores.

In one embodiment, method 400 may be configured to attempt to distribute cores in two different dimensions. One dimension is across the core clusters, the second dimension is the physical layout of the cores (e.g., across the mesh rows and columns of cores). Note that these two dimensions are independent of the number of dimensions used to describe the physical layout of the cores.

At block 420, the physical arrangement of the plurality of cores is determined. As previously described, this may include accessing a core map (e.g., core map 300 in FIG. 3) or other core configuration table/file. This may include determining a total number of currently available cores in a selected core cluster(s) for which the disabling algorithm is applied. The selected core cluster(s) may include one die, multiple dies, or all dies of the CPU. The selected core cluster may include multiple clusters. The system identifies a number of rows and columns of cores that are present across the selected core cluster(s). The total number of currently available cores does not include cores that have been fused, whether fused during manufacturing or by CPU design.

In the following example, the four dies in FIG. 3 (Die 0 to Die 3) may be considered part of the selected core clusters even though each die may be an individual core cluster (e.g., four core clusters). In another embodiment, the Dies 0 to 3 may be grouped into two or more separate core clusters. In one embodiment, the system may determine an association of each core within the plurality of cores to a specific core cluster when multiple core clusters are present. For example, cores that belong to other clusters (that are not part of the selected core cluster) are not included in the disabling process.

At block 430, a current state of each available core is determined, which identifies the enabled cores and disabled cores within the physical arrangement across the selected core cluster(s). For example, hardware configuration settings and/or tables such as the core map 300, may be accessed. The core map 300 labels the current state of each core, which may include for example, enabled/active or disabled. The core map 300 may be accessed by the operating system of the computing system.

There may be different types of disabled states as previously described such as disabled by software (which is reversible), fused disabled by CPU design/architecture to create different CPU product tiers (which is irreversible), or fused disabled during CPU manufacturing to eliminate defective cores (which is irreversible). The core map may use different numbering schemes and/or labels to identify the current state of a core. For example, a currently enabled core may be labeled by its actual core ID number. Disabled cores are labeled differently. For purposes of the present example, method 400 treats all different disabled states of a core as simply a disabled core.

Using the core map 300 of FIG. 3, there are 44 enabled cores (available) and 4 fused disabled cores. The physical locations of the disabled cores within the physical arrangement may be used to identify areas in the CPU that may be overly disabled and/or overly enabled relative to other areas, which becomes a factor in selecting which core(s) to disable. In the following example, the core distribution algorithm executes an iterative process that identifies the area with the most enabled cores and selects one enabled target core to disable. Each time a core is disabled, the physical distribution of disabled cores changes. Then the algorithm repeats for the next target core to disable based on the current physical distribution of disabled cores.

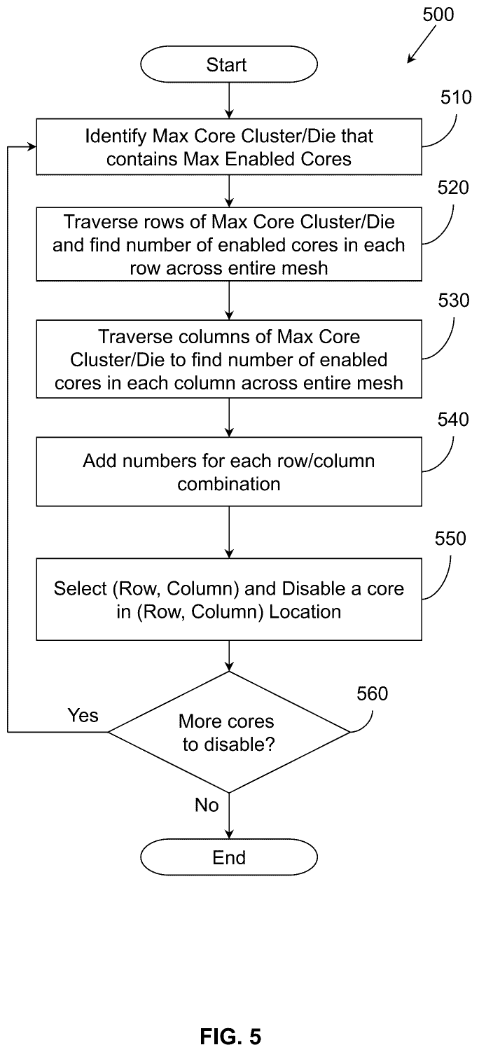

At block 440, for example, a number of target cores to disable are identified from the physical arrangement by selecting the target cores in a manner to create a uniform distribution of enabled and disabled cores across of the core clusters. In one embodiment, the target cores to be selected for disabling are based on creating a balanced physical distribution of disabled cores and enabled cores throughout the physical arrangement of the enabled cores and the disabled cores. Based on the physical distribution of enabled cores and disabled cores, the core distribution algorithm attempts to uniformly distribute the newly disabled cores (e.g., the next core to disable) throughout the physical architecture based on the physical locations of currently enabled cores and currently disabled cores. FIG. 5 provides one embodiment of the identification and selection process for distributing the disabled cores, which is described below.

In one embodiment, block 440 may be executed in an iterative manner. For example, in each iteration, one target core is identified from the most heavily utilized row and column in the core map that has the greatest number of enabled cores. The target core is selected from this location and the process repeats for the next target core, and so on. In one embodiment, the algorithm of method 400 is configured to satisfy two criteria when selecting a core to disable: (1) ensuring uniformity amongst core clusters (e.g., amongst dies) and (2) ensuring cores are uniformly distributed within the mesh.

At block 450, the identified target cores are disabled. In one embodiment, that disabling may be performed by the UEFI firmware disabling the identified cores by updating configuration registers to configure the identified cores as disabled. In another embodiment, this may be performed by sending instructions to the operating system. The operating system may then communicate with the hardware to disable the identified target core(s). This may involve updating configuration registers or Advanced Configuration and Power Interface (ACPI) tables to reflect the new CPU configuration of enabled cores. Once disabled, the disabled cores are no longer available for executing tasks.

In one embodiment, disabling the target cores includes labeling the target cores to be disabled until all target cores are identified. Then upon completion, the UEFI/BIOS updates the configuration registers to configure the identified cores as disabled. In another embodiment, each target core may be labeled and disabled individually.

With the present system 100 and method 400, a novel methodology for distributing cores across dies is provided that address an issue of core imbalance and enhances overall CPU performance. The present method ensures a more equitable distribution of processing power across a CPU and fosters an optimal utilization of the CPU's capabilities. In another embodiment, the CPU may have multi-layers of cores that form a 3-Dimensional matrix of cores (or 3D matrix of clusters). Method 400 may be adjusted and applied to the 3-D matrix of cores/clusters by considering the row x column x depth arrangement and distribution of enabled and disabled cores. In another embodiment, method 400 may be adjusted and applied in a hierarchical manner and spread across different attributes of a CPU, for example, across different dies or clusters.

### Distribution of Disabled Cores Second Embodiment

With reference to FIG. 5, another embodiment of a core distribution algorithm/method 500 is illustrated that may be implemented for block 440 of FIG. 4. Method 500 describes how the core distribution system 100 may be configured to identify which cores to disable. The following will be described based on a starting point using the core map 300 shown in FIG. 3. As seen in core map 300, four core clusters (e.g., one core cluster for each of the four dies) are present across the CPU mesh with a total number of available cores being 44 cores. Four (4) cores out of 48 physically present cores were fused disabled during CPU manufacturing and labeled as “254” and thus are not available cores (non-functioning cores).

In this example, a request to disable eight (8) cores is described. Of course, any number of available cores may be requested to be disabled, which is less than the total available cores. As such, method 500 will have eight iterations where each iteration identifies and selects one core to disable based on a current physical distribution of disabled cores and enabled cores in the physical arrangement.

At block 510, the method identifies a max cores cluster from the present clusters/dies that contains a greatest number of enabled cores (max enabled cores) relative to the other clusters/dies. This is to ensure disabling is evenly distributed across all clusters/dies (across the entire CPU mesh). The cluster/die with the most enabled cores is selected as the target cluster/die during each iteration to ensure that the maximum difference in enabled core count between all of the dies is no more than one, in one embodiment. One core will be disabled on this target cluster/die first.

Looking at the core map 300 of FIG. 3, in the first iteration, there are 44 enabled cores. The number of cores to disable is 8 cores. In the end, the number of cores that are remaining as enabled is 36 cores. From the four dies (Die 0, Die 1, Die 2, and Die 3), the greatest number of enabled cores is 11, which each cluster/die contains. When more than one cluster/die has the same number of enabled cores as the maximum number of cores enabled on any one of the clusters/dies, the core distribution algorithm may select any one of the max clusters/dies. In this embodiment, the die with the highest ID number is selected, which is Die 3.

At block 520, the rows of Max Die 3 are traversed to find a total number of enabled cores in each row across the entire CPU mesh. In FIG. 3, Die 3 is located in rows 3, 4, and 5. Counting the number of enabled cores across the entire mesh in those rows results in: row [3]=7 enabled cores; row [4]=8 enabled cores; row [5]=7 enabled cores. Fused disabled cores (labeled “254”) are disabled and not counted. This step identifies row locations in the mesh with the most enabled cores.

At block 530, the columns of Max Die 3 are traversed to find a total number of enabled cores in each column across the entire CPU mesh. Again, looking at the core map 300 in FIG. 3, die 3 is located in columns 4, 5, 6, and 7. Counting the number of enabled cores across the entire mesh in those columns results in: column [4]=6 enabled cores; column [5]=5 enabled cores; column [6]=6 enabled cores; column [7]=5 enabled cores. This step identifies column locations in the mesh with the most enabled cores.

At block 540, the row and column results are combined (e.g., added together) for each row and column combination. This provides a summed combination of enabled cores from the rows and columns, which is used to identify an area in the core map that includes a greatest number of enabled cores. Table 1 shows example results from each step.

### Table 1

### First Iteration-Based on Max Die 3

Block 520: Row Results based on Max Die 3
   Row [3]=7 enabled cores
   Row [4]=8 enabled cores
   Row [5]=7 enabled cores
Block 530: Column Results based on Max Die 3
   Column [4]=6 enabled cores
   Column [5]=5 enabled cores
   Column [6]=6 enabled cores
   Column [7]=5 enabled cores
Add for Each Row/Column Combination
   Row [3] (7)+Column [4] (6)=13<- - - Current Max=13
   Row [3] (7)+Column [5] (5)=12
   Row [3] (7)+Column [6] (6)=13
   Row [3] (7)+Column [7] (5)=12
   Row [4] (8)+Column [4] (6)=14<- - - Current Max=14
   Row [4] (8)+Column [5] (5)=13
   Row [4] (8)+Column [6] (6)=14
   Row [4] (8)+Column [7] (5)=13
   Row [5] (7)+Column [4] (6)=13
   Row [5] (7)+Column [5] (5)=12
   Row [5] (7)+Column [6] (6)=13
   Row [5] (7)+Column [7] (5)=12
Result: Disabling Row [4] Column [4]=Core 040

During each row/column combination, the core distribution algorithm tracks the current maximum value and updates the max value if the value is exceeded. After all combinations are added, the Max combined value of enabled cores is found at row 4, column 4. The core identified at this physical location in the core map 300 is core 040. Thus, in this iteration, this is the location/area with the greatest number of enabled cores. This physical location/area in the CPU may also be considered the highest concentration or ratio of enabled cores, and thus, is the target area to disable a core. As such, core 040 is the target core and is selected to be disabled at block 550.

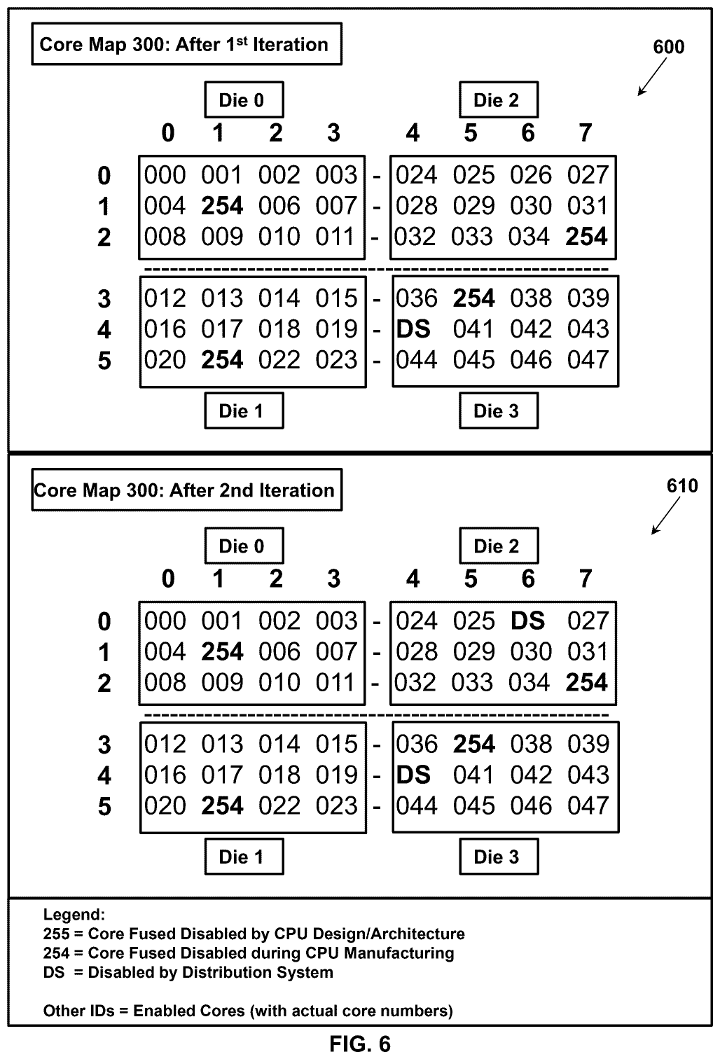

FIG. 6 shows the core map after the first iteration (current state 600) and shows core 040 labeled as “DS” to represent it is disabled by the core distribution system. Of course, other types of IDs may be used to identify a software disabled core based on, for example, the core numbering scheme of a particular operating system.

With reference again to FIG. 5, at block 560, the system determines if more cores are to be disabled. Since the requested number to disable is 8 cores, there are 7 more cores to disable. Method 500 returns to block 510 and repeats the algorithm on the current state 600 of the core map. As previously stated, since a new core has been disabled, the physical distribution of disabled cores has now changed, which may impact the decision for selecting the next target core to disable.

For the second iteration, the current state 600 of the core map is used. With reference to FIG. 5, starting at block 510 of method 500, the most enabled cores on a die is 11 cores, which Die 0, Die 1, and Die 2 all contain. One of these dies is selected as the new Max Die, for example, select the highest die ID, which is Die number 2 but any other max die may have been selected. Method 500 is repeated on Die 2.

Table 2 shows the core distribution algorithm steps and determinations during the second iteration for Max Die 2. Based on the core map 300 (FIG. 6), Die 2 is located across rows 0, 1, and 2, and columns 4, 5, 6, and 7.

### Table 2

### Second Iteration-Based on Max Die 2

Block 520: Row Results based on Max Die 2
   Row [0]=8 enabled cores
   Row [1]=7 enabled cores
   Row [2]=7 enabled cores
Block 530: Column Results based on Max Die 2
   Column [4]=5 enabled cores
   Column [5]=5 enabled cores
   Column [6]=6 enabled cores
   Column [7]=5 enabled cores
Add for Each Row/Column Combination
   Row [0] (8)+Column [4] (5)=13<- - - Current Max=13
   Row [0] (8)+Column [5] (5)=13
   Row [0] (8)+Column [6] (6)=14<- - - Current Max=14
   Row [0] (8)+Column [7] (5)=13
   Row [1] (7)+Column [4] (5)=12
   Row [1] (7)+Column [5] (5)=12
   Row [1] (7)+Column [6] (6)=13
   Row [1] (7)+Column [7] (5)=12
   Row [2] (7)+Column [4] (5)=12
   Row [2] (7)+Column [5] (5)=12
   Row [2] (7)+Column [6] (6)=13
   Row [2] (7)+Column [7] (5)=12
Result: Disabling Row [0] Column [6]=Core 026

After all row/column combinations of enabled cores across all dies are added based on Max Die 2, the Max combined value of enabled cores is found at row 0, column 6. The core identified at this physical location in the core map 300 is core 026. Thus, in the second iteration, this is the location/area with the greatest number of enabled cores. As such, core 026 is the target core and is selected to be disabled at block 550.

FIG. 6 shows core map 300 after the second iteration with current state 610 after core 026 is labeled as “DS” to represent it is disabled by the distribution system. In general, the disabled core ID identifies that the core is disabled by software (disabled status) and is thus reversible. Software disabled cores may be enabled by changing the core ID to an enabled status, for example, by listing the core's actual ID number in the core map.

Repeating method 500 to identify and disable the remaining number of cores, the following are results from each iteration:
Iteration 3:
   Target Max Die 1: Disabling Row 3: Column 0-Core 012
Iteration 4:
   Target Max Die 0: Disabling Row 0: Column 2=Core 002
Iteration 5:
   Target Max Die 3: Disabling Row 4: Column 5=Core 041
Iteration 6:
   Target Max Die 2: Disabling Row 1: Column 4=Core 028
Iteration 7:
   Target Max Die 1: Disabling Row 5: Column 3=Core 023
Iteration 8:
   Target Max Die 0: Disabling Row 2: Column 0=Core 008

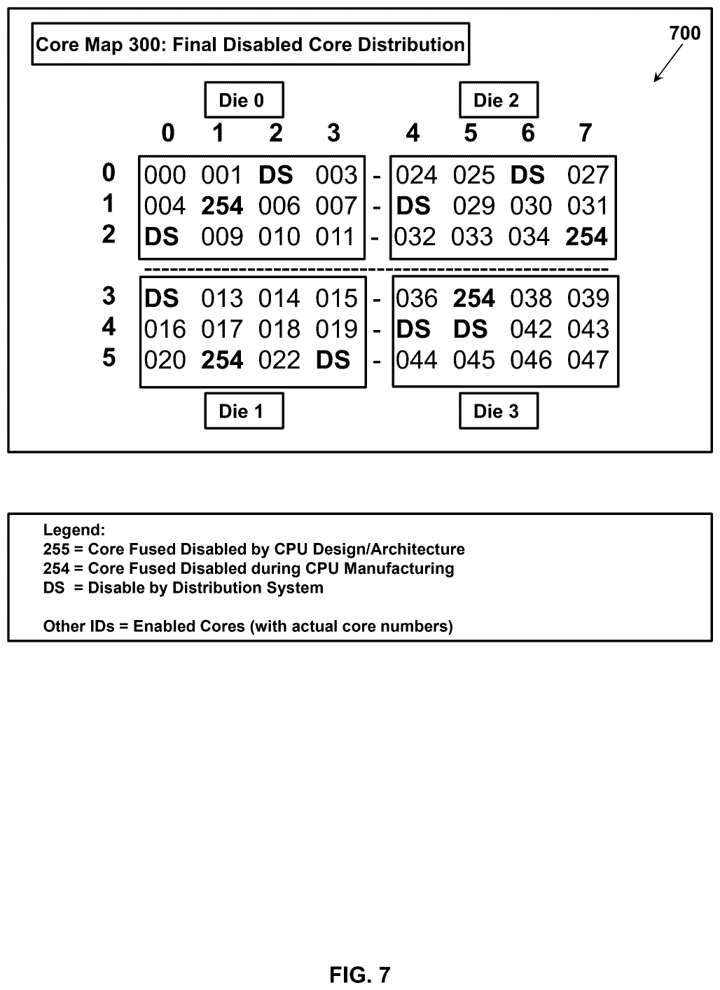

With Reference to FIG. 7, a final state 700 of the core map is shown with the eight (8) disabled cores labeled “DS” that were disabled by the core distribution system 100. Overall, the disabled cores are uniformly distributed and balanced throughout the physical arrangement of the multi-die CPU. By identifying target cores to disable based on a current (real-time) state of enabled core locations and disabled core locations, the core distribution system 100 creates a uniform physical distribution of disabled cores and enabled cores upon completion regardless of how many cores are disabled.

In another embodiment, the core distribution system 100 may be triggered by a user request to modify the number of active cores in response to increased or decreased system load. For example, if the load on the system is reduced the user may disable a subset of the currently enabled cores to reduce power consumption or software licensing costs tied to the number of active cores.

The core distribution system 100 may access the core map, identify a current set of core IDs that are currently disabled by software (e.g., reversible state, not fused disabled), and determine the number of core IDs that are currently disabled by software. The core distribution system 100 may then start with an initial core map that enables the software disabled cores (e.g., treats them as enabled) and executes the core distribution algorithm to disable the same number of cores using method 400 and/or method 500. Thus, the current number of disabled cores are redistributed in the physical arrangement. Upon completion, a new arrangement of enabled and disabled cores may result, which may resolve the detected trigger condition that initiated the process.

### Distribution of Disabled Cores in Out-of-Shape CPU Embodiment

In another embodiment, the core distribution system 100 may be configured to distribute disabled cores in an out-of-shape CPU that includes out-of-shape dies by first converting the CPU to an in-shape CPU with in-shape dies. As previously stated, an out-of-shape CPU is a CPU with an irregular mesh topology and an in-shape CPU is a CPU with a regular mesh topology. This also applies to an irregular core cluster, which is a single die that has one or more missing cores. Once the CPU (or core cluster) is converted to be in-shape, the previous core disabling and distribution methods may be applied as described with reference to FIGS. 4 and 5. Thus, the core distribution system 100 is configured to distribute disabled cores across all dies, addressing the issue of imbalance and enhancing overall CPU performance. This innovative approach ensures a more equitable distribution of processing power, fostering optimal utilization of a CPU's capabilities.

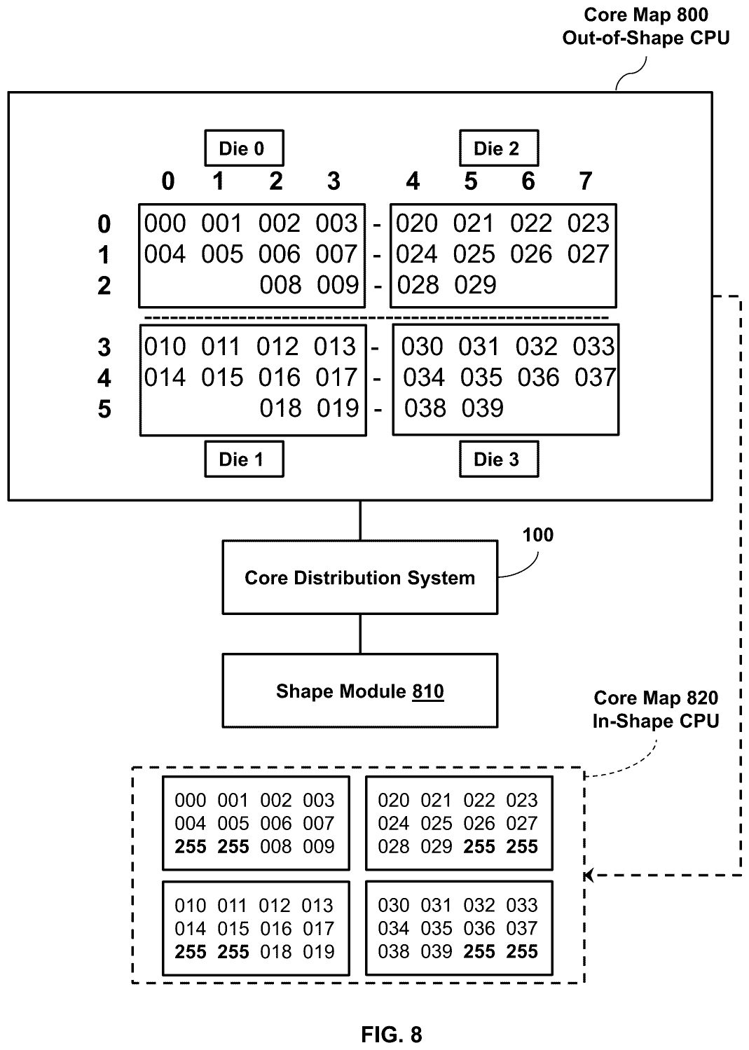

With reference to FIG. 8, one embodiment of an out-of-shape core map 800 is shown that represents an out-of-shape CPU with multiple dies. As previously described, when a die in the CPU (e.g., a core cluster) has one or more cores that are missing in the matrix, then the die, the core cluster, and/or the CPU have an incomplete N×M matrix of cores. This is referred to as an “out-of-shape” or irregular configuration of cores. For example, one or more cores may be missing in the matrix because the cores were intentionally not included for a particular CPU design during manufacturing of the CPU.

In FIG. 8, the overall matrix of the CPU mesh includes four (4) dies and covers a 6×8 matrix of cores. Rows are labeled 0 to 5 and columns are labeled 0 to 7. As seen in row 2 and row 5, columns 0, 1, 6, and 7 do not include a core. Thus, the 6×8 matrix of cores is incomplete and is considered out-of-shape.

In one embodiment, the core distribution system 100 may include a shape module 810 configured to determine whether a target CPU is in-shape or out-of-shape and convert out-of-shape dies to be in-shape. For example, the shape module 810 may be configured to access a core map and determine the physical arrangement of the entire CPU mesh including a number of rows and columns that include a core. Determining the physical arrangement may also include determining the number of dies, the number of physically present cores (which include fused disabled cores) based on core ID, and a 2-Dimensional size of the CPU matrix/grid based on rows and columns. Using this information, the shape module 810 can determine whether any (row, column) locations do not include a core.

When the shape module 810 determines that the CPU is out-of-shape, any out-of-shape dies are converted to be in-shape for the purpose of applying method 400. The same function may be applied to one or more irregular core clusters that may be present. In one embodiment, the shape module 810 inserts simulated disabled core IDs into the core map 800 to fill locations that do not include a core ID. Of course, these simulated disabled core IDs represent simulated cores that are non-existent and are not physically present in the CPU. They mimic an actual core. As such, the physical arrangement of the CPU appears to have been changed but has only changed logically in system settings.

With continued reference to FIG. 8, example core map 820 shows a result of adding four (4) simulated disabled cores into the core map 800. Each simulated disabled core is represented by a core ID “255.” In some systems, a core ID of 255 represents a core that has been fused disabled by CPU design/architecture. Of course, other types of core IDs may be used represent a simulated disabled core based on core ID numbering schemes used by a particular operating system. In effect, the simulated disabled core ID inserted into the core map mimics a physically present core that has been fused and thus cannot be enabled.

Upon completion of the shape conversion, the core map 820 now has a complete 6×8 matrix of cores. The core distribution algorithms of method 400 (FIG. 4) or method 500 (FIG. 5) may then be performed on the associated multi-die CPU in the same manner as an in-shape CPU to disable a selected number of cores as previously described.

In another embodiment, the core distribution algorithms of method 400 or method 500 may be performed on an out-of-shape CPU directly without conversion. For example, any missing cores in an N×M matrix are treated as disabled cores by default without adding simulated cores to the core map.

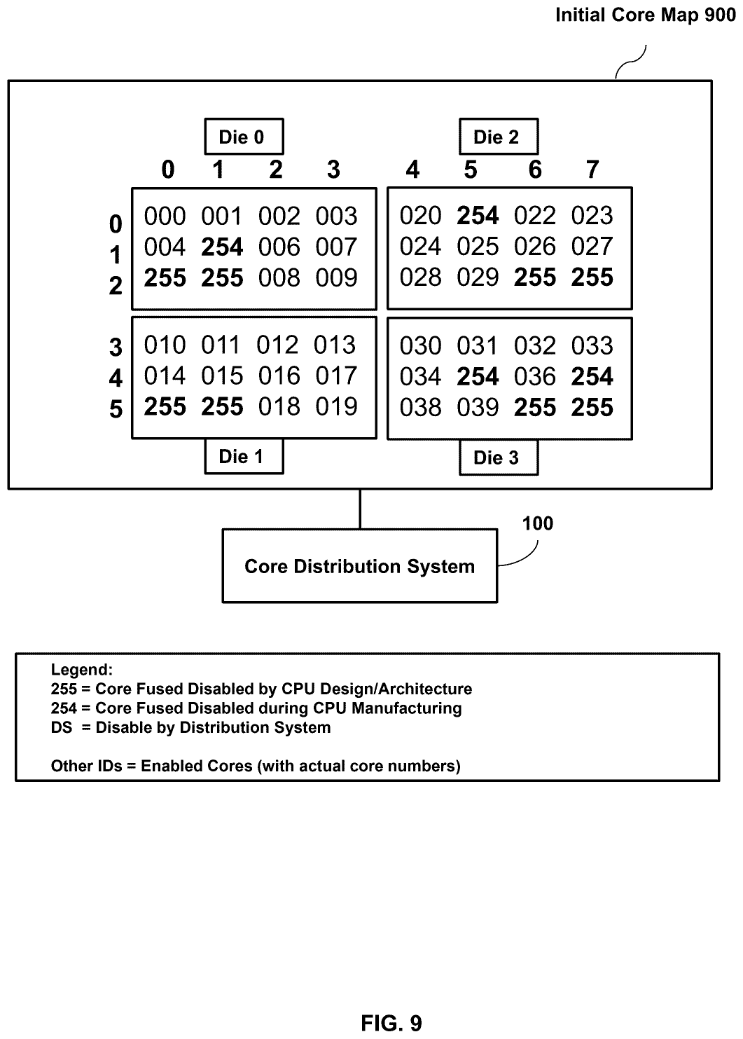

With reference to FIG. 9, one embodiment of an initial core map 900 is illustrated to be used in another example of distributing disabled cores. The present system and method are not limited to the example core arrangement since any initial core map may be used.

Initial core map 900 is based on the converted core map 820 (now in-shape) that includes the simulated disabled core IDs 255. The core map 900 further includes four (4) additional fused disabled cores to provide a different starting configuration and relationship of enabled cores and disabled cores. Here, the fused disabled cores are labeled with IDs “254” representing cores 005, 021, 035, and 037 that were fused during CPU manufacturing.

The core distribution method 500 (FIG. 5) will be used to demonstrate a process of selecting and distributing a number of disabled cores upon a request for a CPU that has been converted from being out-of-shape to being in-shape.

With reference to method 500 of FIG. 5 and the initial core map 900 of FIG. 9, the algorithm of the core distribution system 100 may be triggered by receiving a request to disable a specified number of cores. For example, the request to disable may be received from the UEFI/BIOS of the associated computing system. The core distribution system 100 may determine the initial configuration of the CPU core architecture from by accessing the core map 900 and/or other system configuration settings or tables. The core map 900 shows a physical arrangement that is a 6×8 matrix of cores.

As seen in the initial core map 900, the CPU has four dies with a total of 40 actual cores in the CPU labeled with core IDs 000 to 039. Note that cores labeled 255 are simulated from the previous conversion process. Additionally, four cores were fused during manufacturing, which are identified by the core IDs “254.” Therefore, the total available number of enabled/active cores is 36. The following example will process a request to disable 4 cores, or conversely, to enable 32 cores out of the total 36 enabled cores.

As previously described with reference to method 500, there will be four iterations to disable cores. Each iteration identifies one core to disable based on the current state of the physical arrangement/locations of enable cores and disabled cores in the CPU.

At block 510, method 500 identifies a max die from the present dies that contains a greatest number of enabled cores (max enabled cores) relative to the other dies. From the four dies (Die 0, Die 1, Die 2, and Die 3) in the initial core map 900 (FIG. 9), the greatest number of enabled cores is 10, which Die 1 contains. Die 1 is selected as the Max Die from which the first core will be disabled.

At block 520, the rows of Max Die 1 are traversed to find a total number of enabled cores in each row across the entire CPU mesh. In FIG. 9, die 1 is located in rows 3, 4, and 5 in the matrix. Counting the number of enabled cores across the entire mesh in those rows results in: row [3]=8 enabled cores; row [4]=6 enabled cores; row [5]=4 enabled cores. Cores labeled “255” are disabled and not counted. This step identifies row locations in the mesh with the most enabled cores.

At block 530, the columns of Max Die 1 are traversed to find a total number of enabled cores in each column across the entire CPU mesh. Again, looking at the core map 900 in FIG. 9, die 1 is located in columns 0, 1, 2, and 3. Counting the number of enabled cores across the entire mesh in those columns results in: column [0]=4 enabled cores; column [1]=3 enabled cores; column [2]=6 enabled cores; column [3]=6 enabled cores. This step identifies column locations in the mesh with the most enabled cores.

At block 540, the row and column results are combined (e.g., added together) for each row and column combination. This provides a summed combination of enabled cores from the rows and columns, which is used to identify an area in the core map that includes a greatest number of enabled cores. Table 3 shows example results from each step.

### Table 3

### First Iteration-Based on Max Die 1

Block 520: Row Results based on Max Die 1
   Row [3]=8 enabled cores
   Row [4]=6 enabled cores
   Row [5]=4 enabled cores
Block 530: Column Results based on Max Die 1
   Column [0]=4 enabled cores
   Column [1]=3 enabled cores
   Column [2]=6 enabled cores
   Column [3]=6 enabled cores
Add for Each Row/Column Combination
   Row [3] (8)+Column [0] (4)=12<- - - Current Max=12
   Row [3] (8)+Column [1] (3)=11
   Row [3] (8)+Column [2] (6)=14<- - - Current Max=14
   Row [3] (8)+Column [3] (6)=14
   Row [4] (6)+Column [0] (4)=10
   Row [4] (6)+Column [1] (3)=9
   Row [4] (6)+Column [2] (6)=12
   Row [4] (6)+Column [3] (6)=12
   Row [5] (4)+Column [0] (4)=8
   Row [5] (4)+Column [1] (3)=7
   Row [5] (4)+Column [2] (6)=10
   Row [5] (4)+Column [3] (6)=10
Result: Disabling Row [3] Column [2]=Core 012

As previously explained, during each row/column combination, the algorithm tracks the current maximum value and updates the max value if the value is exceeded. After all combinations are added, the Max combined value of enabled cores is found at row 3, column 2. The core identified at this physical location in the core map is core 012. Thus, in this iteration, this is the location/area with the greatest number of enabled cores. This physical location/area in the CPU may also be considered the highest concentration or ratio of enabled cores, and thus, is the target area to disable a core. As such, core 012 is the target core and is selected to be disabled at block 550 (FIG. 5).

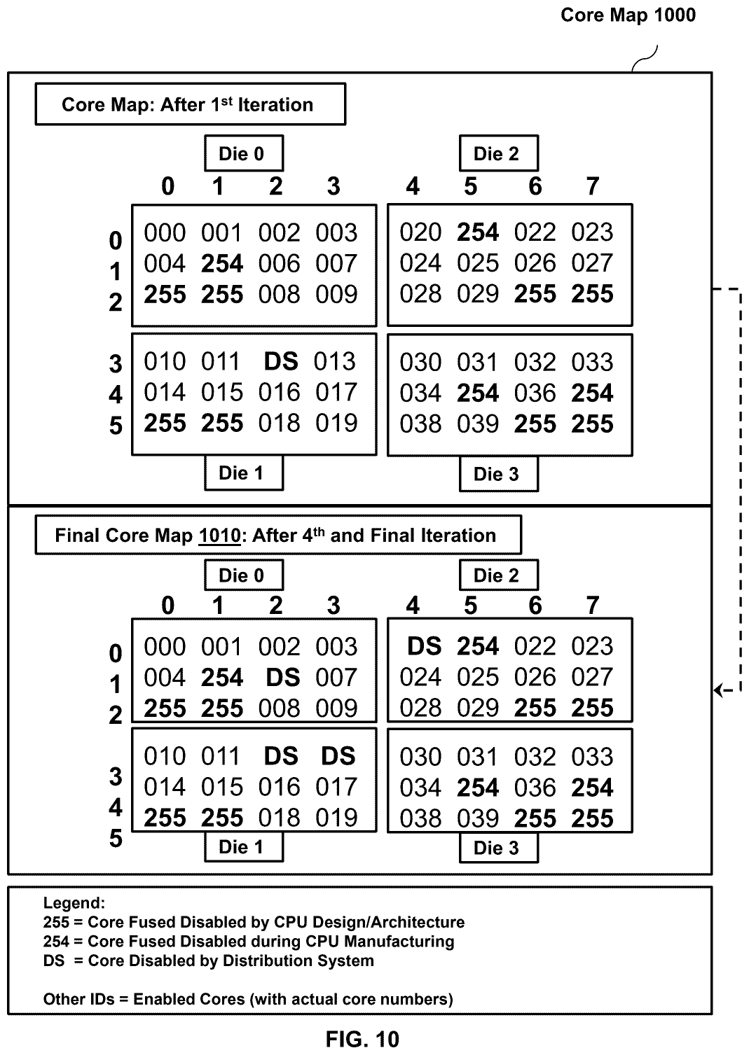

With reference to FIG. 10, core map 1000 shows the current state of the CPU after the first iteration and shows core ID 012 now labeled as “DS” to represent it is disabled by the core distribution system 100. Of course, other types of IDs may be used to identify a software disabled core based on, for example, the core numbering scheme of a particular operating system.

With reference again to FIG. 5, at block 560, the system determines if more cores are to be disabled. Since the requested number to disable is 4 cores, there are 3 more cores to disable. Method 500 returns to block 510 and repeats the algorithm on the current state of the core map 1000. As previously stated, since a new core has been disabled, the physical distribution of disabled cores has now changed, which may impact the decision for selecting the next target core to disable.

Method 500 is repeated for the three (3) remaining cores to disable. Table 4 illustrates the result of each iteration. FIG. 10 illustrates the final core map 1010 after four cores have been selected and disabled (labeled “DS”) that were disabled by the core distribution system 100.

### Table 4

### Results of Four Iterations to Disable Four Cores

### Based On Initial Core Map 900

Iteration 1:
   Target Max Die 1: Number of enable cores=9
   Disabling Row 3: Column 2=Core 012
Iteration 2:
   Target Max Die 2: Number of enabled cores=9
   Disabling Row 0: Column 4=Core 020
Iteration 3:
   Target Max Die 1: Number of enabled cores=9
   Disabling Row 3: Column 3=Core 013
Iteration 4:
   Target Max Die 0: Number of enabled cores=9
   Disabling Row 1: Column 2=Core 006

Overall, the disabled cores are uniformly distributed and/or balanced throughout the physical arrangement of the multi-die CPU. This also creates a uniform distribution of the enabled cores throughout the CPU. By identifying target cores to disable based on a current (real-time) state of enabled core locations and disabled core locations, the core distribution system 100 creates a balanced physical distribution of disabled cores and enabled cores upon completion regardless of how many cores are disabled. The balanced physical distribution of cores is a more uniform distribution as compared to prior techniques.

The present core distribution system 100 and associated methods provide advantages and improvements to previous core disabling techniques. For example, the present system allows the ability to apply cores distribution to irregular shaped CPU dies (out-of-shape) and provide a balanced distribution of enabled and disabled cores in a multi-die CPU. The balanced distribution of the present system and method further improves the performance of cache-bound transactions between cores and between dies, as well as improves overall signal traffic across the entire CPU.

As previously explained, prior core disabling techniques that selected cores in a sequential manner by core ID created an imbalanced distribution of cores. This caused certain areas of the CPU to become hotspots while other areas remain cool due to excessive disabled cores in one area. This prior type of core distribution has led to thermal imbalance and potential thermal throttling, which is resolved by the present system and method.

### Cloud or Enterprise Embodiments

In one embodiment, the core distribution system 100 may be a computing/data processing system including an application or collection of distributed applications for enterprise organizations. The applications and computing system 100 may be configured to operate with or be implemented as a cloud-based networking system, a software as a service (SaaS) architecture, or other type of networked computing solution. In one embodiment, the core distribution system is a centralized server-side application that provides at least the functions disclosed herein and that is accessed by many users via computing devices/terminals communicating with a computing system (functioning as the server) over a computer/communication network.

In one embodiment, one or more of the components described herein are configured as program modules stored in a non-transitory computer readable medium. The program modules are configured with stored instructions that when executed by at least a processor cause a computing system to perform the corresponding function(s) as described herein.

### Computing Device Embodiment

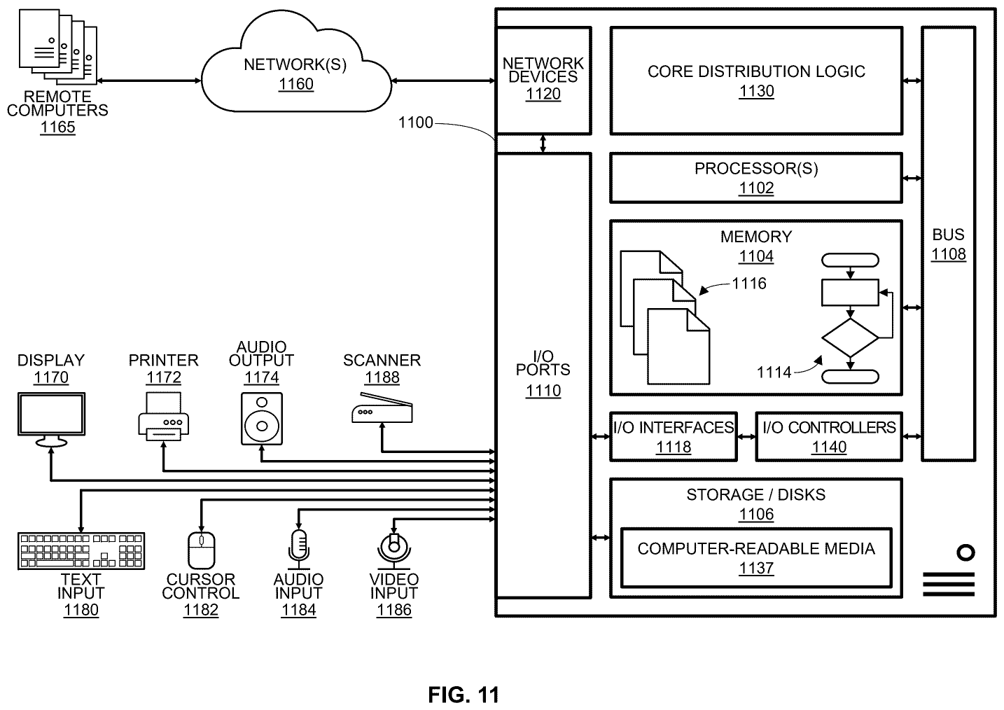

FIG. 11 illustrates an example computing device that is configured and/or programmed as a special purpose computing device with one or more of the example systems and methods described herein, and/or equivalents. The example computing device may be a server or other type of computer 1100 that is part of a multi-computing device system. The computer 1100 may include at least one hardware processor 1102, a memory 1104, and input/output ports 1110 operably connected by a bus 1108. In one example, the computer 1100 may include core distribution logic 1130 configured to facilitate core distribution of disabled and enabled cores similar to core distribution system 100 shown in previous figures and associated methods.

In different examples, the core distribution logic 1130 may be implemented in hardware, a non-transitory computer-readable medium 1137 with stored instructions, firmware, and/or combinations thereof. While the logic 1130 is illustrated as a hardware component attached to the bus 1108, it is to be appreciated that in other embodiments, the core distribution logic 1130 could be implemented in the processor 1102, stored in memory 1104, or stored in disk 1106.

In one embodiment, logic 1130 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate core distribution of disabled and enabled cores similar to core distribution system 100. The means may also be implemented as stored computer executable instructions that are presented to computer 1100 as data 1116 that are temporarily stored in memory 1104 and then executed by processor 1102.

Logic 1130 may also provide means (e.g., hardware, non-transitory computer-readable medium that stores executable instructions, firmware) for performing one or more of the disclosed functions and/or combinations of the functions.

Generally describing an example configuration of the computer 1100, the processor 1102 may be a variety of various processors including dual microprocessor and other multi-processor architectures. Memory 1104 may include volatile memory and/or non-volatile memory. Non-volatile memory may include, for example, ROM, PROM, and so on. Volatile memory may include, for example, RAM, SRAM, DRAM, and so on.

A storage disk 1106 may be operably connected to the computer 1100 via, for example, an input/output (I/O) interface (e.g., card, device) 1118 and an input/output port 1110 that are controlled by at least an input/output (I/O) controller 1140. The disk 1106 may be, for example, a magnetic disk drive, a solid state disk drive, a floppy disk drive, a tape drive, a Zip drive, a flash memory card, a memory stick, and so on. Furthermore, the disk 1106 may be a CD-ROM drive, a CD-R drive, a CD-RW drive, a DVD ROM, and so on. The memory 1104 can store a process 1114 and/or a data 1116, for example. The disk 1106 and/or the memory 1104 can store an operating system that controls and allocates resources of the computer 1100.

The computer 1100 may interact with, control, and/or be controlled by input/output (I/O) devices via the input/output (I/O) controller 1140, the I/O interfaces 1118, and the input/output ports 1110. Input/output devices may include, for example, one or more displays 1170, printers 1172 (such as inkjet, laser, or 3D printers), audio output devices 1174 (such as speakers or headphones), text input devices 1180 (such as keyboards), cursor control devices 1182 for pointing and selection inputs (such as mice, trackballs, touch screens, joysticks, pointing sticks, electronic styluses, electronic pen tablets), audio input devices 1184 (such as microphones or external audio players), video input devices 1186 (such as video and still cameras, or external video players), image scanners 1188, video cards (not shown), disks 1106, network devices 1120, and so on. The input/output ports 1110 may include, for example, serial ports, parallel ports, and USB ports.

The computer 1100 can operate in a communication network environment and thus may be connected to the network devices 1120 via the I/O interfaces 1118, and/or the I/O ports 1110. Through the network devices 1120, the computer 1100 may interact with a network 1160. Through the network, the computer 1100 may be logically connected to remote computers 1165. Networks with which the computer 1100 may interact include, but are not limited to, a LAN, a WAN, and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (Saas) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions.

An “operable connection”, or a connection by which entities are “operably connected”, is one in which one or more communication channels are established that allow signals, data, messages, physical communications, and/or logical communications to be sent and/or received between the entities. An operable connection may include a physical interface, an electrical interface, and/or a data interface with one or more transmitters/receivers that communicate with wired and/or wireless signals. An operable connection may include differing combinations of interfaces and/or connections sufficient to establish and allow communication. For example, two entities can be operably connected to communicate signals to each other directly or through one or more intermediate entities (e.g., processor, operating system, logic, non-transitory computer-readable medium, internet communication devices, local network, etc.). Logical and/or physical communication channels can be used to create an operable connection.

“User”, as used herein, includes but is not limited to one or more persons, computers or other devices, or combinations of these. In one embodiment, a user request may include a request generated by an algorithm or other component of a computing device.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A non-transitory computer-readable medium that includes stored thereon computer-executable instructions that when executed by at least a processor of a computing system, wherein the computing system includes one or more computing devices, cause the computing system to:
receive a request to disable a number of cores in a processing unit, wherein the processing unit includes a physical arrangement of one or more core clusters, wherein each core cluster includes a plurality of cores;
determine the physical arrangement of the plurality of cores including rows and columns of cores;
determine an association of each core within the plurality of cores to a specific core cluster;
identify enabled cores and disabled cores within the physical arrangement;
identify a number of target cores to disable from the physical arrangement by selecting the target cores to create a uniform distribution of enabled and disabled cores across of the one or more core clusters; and
disable the target cores selected.

2. The non-transitory computer-readable medium of claim 1, further comprising instructions that when executed by at least the processor cause the processor to:
wherein selecting the target cores to create the uniform distribution of disabled cores and enabled cores comprises:
executing an algorithm that uniformly distributes the selected cores to disable throughout the physical arrangement based on physical locations of currently enabled cores and currently disabled cores.

3. The non-transitory computer-readable medium of claim 1, wherein the instructions for selecting target cores to create the uniform distribution of enabled and disabled cores further comprises instructions configured to:
(i) identify a max cores cluster from one or more core clusters of the processing unit that includes a greatest number of enabled cores in relation to the other core clusters;
(ii) within the max cores cluster, identify a target core at a location based on the rows and the columns across the processing unit that include a greatest number of enabled cores;
(iii) disable the target core; and
repeat functions (i), (ii), and (iii) until the requested number of cores to disable are disabled.

4. The non-transitory computer-readable medium of claim 1, further comprising instructions that when executed by at least the processor cause the processor to:
determine the physical arrangement of the plurality of cores from a core map that defines the plurality of cores arranged in rows and columns in the processing unit;
identify an area in the core map that includes a greatest number of enabled cores based on a summed combination of enabled cores from the rows and columns; and
select a target enabled core in the area and disable the target enabled core.

5. The non-transitory computer-readable medium of claim 1, further comprising instructions that when executed by at least the processor cause the processor to:
select a first core cluster from one or more core clusters in the processing unit that includes a greatest number of enabled cores from the plurality of cores;
in the selected first core cluster, identify and select a most heavily utilized row and column in a core map including a row and column combination having a maximum number of enabled cores, where the row and column identifies a target core; and
disabling the target core associated with the row and column location.

6. The non-transitory computer-readable medium of claim 1, wherein the instructions further comprising instructions that when executed by at least the processor cause the processor to:
determine whether the physical arrangement represented by a core map includes an irregular core cluster;
wherein the irregular core cluster has one or more missing cores that are not present in one or more locations on the irregular core cluster causing the irregular core cluster to have an incomplete matrix of cores; and
for the one or more locations that do not have a core present, insert a simulated disabled core into the core map to convert the irregular core cluster to a regular core cluster.

7. The non-transitory computer-readable medium of claim 1, wherein the instructions for selecting the target cores to create the uniform distribution of enabled and disabled cores further comprising instructions that when executed by at least the processor cause the processor to:
distribute cores in two different dimensions including a first dimension across the one or more core clusters and a second dimension across a physical layout of the plurality of cores.

8. A computing system, comprising:
one or more computing devices operably connected to communicate over one or more communication networks via one or more network interfaces;
at least one processing unit connected to at least one memory, wherein the at least one processing unit is operably connected to at least one of the one or more computing devices; and
a core distribution system configured on a non-transitory computer readable medium including instructions stored thereon that when executed by at least the processing unit cause the computing system to:
receive a request to disable a number of cores in a processing unit, wherein the processing unit includes a physical arrangement of one or more core clusters including a plurality of cores;
determine the physical arrangement of the plurality of cores including rows and columns of cores;
determine an association of each core within the plurality of cores to a specific core cluster from the one or more core clusters;
identify enabled cores and disabled cores within the physical arrangement;
identify a number of target cores to disable from the physical arrangement by selecting the target cores to create a uniform distribution of enabled and disabled cores across of the one or more core clusters; and
disable the target cores selected.

9. The computing system of claim 8, wherein the core distribution system is configured to select the cores to create the uniform distribution of disabled cores and enabled cores by:
executing an algorithm that uniformly distributes the selected cores to disable throughout the physical arrangement based on physical locations of currently enabled cores and currently disabled cores.

10. The computing system of claim 8, wherein the plurality of cores are arranged on one or more dies within the processing unit, wherein each die is associated with a core cluster;
wherein the core distribution system is configured to select the cores to create the uniform distribution of disabled cores and enabled cores by:
(i) identifying a max cores cluster from the one or more core clusters that includes a greatest number of enabled cores in relation to the other core clusters;
(ii) within the max cores cluster, identifying a target core at a location based on the rows and the columns across the processing unit that include a greatest number of enabled cores;
(iii) disabling the target core; and
repeating functions (i), (ii), and (iii) until the requested number of cores to disable are disabled.

11. The computing system of claim 8, wherein the core distribution system is further configured to:
determine the physical arrangement of the plurality of cores from a core map that defines the plurality of cores arranged in rows and columns;
identify an area in the core map that includes a greatest number of enabled cores based on a summed combination of enabled cores from the rows and columns; and
select a target enabled core in the area and disable the target enabled core.

12. The computing system of claim 8, wherein the core distribution system is further configured to:
determine whether the physical arrangement of the plurality of cores includes an irregular core cluster;
wherein the irregular core cluster has one or more missing cores that are not present in one or more locations on a die associated with the irregular core cluster causing the irregular core cluster to have an incomplete matrix of cores; and
for the one or more locations that do not have a core present, insert a simulated disabled core into a core map to convert the irregular core cluster to a regular core cluster.

13. The computing system of claim 8, wherein the core distribution system is further configured to disable the identified target cores via instructions between a Unified Extensible Firmware Interface or Basic Input/Output System of the computing system and an operating system of the computing system.

14. A computer-implemented method, the method comprising:
receiving a request to disable a number of cores in a processing unit, wherein the processing unit includes one or more core clusters, wherein each core cluster of the one or more core clusters comprises a physical arrangement of a plurality of cores;
distributing plurality of cores across the one or more core clusters and across the physical arrangement of the plurality of cores, wherein the distributing comprises:
determining the physical arrangement of the plurality of cores including rows and columns of cores;
identifying enabled cores and disabled cores within the physical arrangement;
identifying a number of target cores to disable from the physical arrangement by selecting the target cores to create a uniform physical distribution of the disabled cores and the enabled cores throughout the physical arrangement of the plurality of cores; and
disabling the identified target cores.

15. The method of claim 14, wherein selecting cores to create the uniform distribution of disabled cores and enabled cores comprises:
executing an algorithm that uniformly distributes the selected cores to disable throughout the physical arrangement based on physical locations of currently enabled cores and currently disabled cores.

16. The method of claim 14, wherein selecting target cores to create the uniform physical distribution of disabled cores and enabled cores further comprises:
(i) identifying a max cores cluster from the one or more core clusters that includes a greatest number of enabled cores in relation to the other dies;
(ii) within the max cores cluster, identifying a target core at a location based on the rows and the columns across the processing unit that include a greatest number of enabled cores;
(iii) disabling the target core; and
repeating (i), (ii), and (iii) until the requested number of cores to disable are disabled.

17. The method of claim 14, further comprising:
determining the physical arrangement of the plurality of cores from a core map that defines the plurality of cores for the one or more core clusters arranged in rows and columns;
identifying an area in the core map that includes a greatest number of enabled cores based on a summed combination of enabled cores from the rows and columns; and
selecting a target enabled core in the area and disabling the target enabled core.

18. The method of claim 14, further comprising:
selecting a first core cluster from the one or more core clusters that includes a greatest number of enabled cores from the plurality of cores;
in the selected first core cluster, identifying and selecting a most heavily utilized row and column in a core map including a row and column combination having a maximum number of enabled cores, where the row and column identifies a target core; and
disabling the target core associated with the row and column location.

19. The method of claim 14, wherein the plurality of cores is arranged on one or more dies within the processing unit, wherein each die is associated with a different core cluster, wherein the method further comprises:
determining whether the physical arrangement represented by a core map of the processing unit includes an irregular core cluster;
wherein the irregular core cluster has one or more missing cores that are not present in one or more locations on the associated die causing the irregular core cluster to have an incomplete matrix of cores; and
for the one or more locations that do not have a core present, inserting a simulated disabled core into the core map to convert the irregular core cluster to a regular core cluster.

20. The method of claim 14, wherein selecting the target cores to create the uniform physical distribution of disabled cores and enabled cores further comprising:
distributing cores in two different dimensions including a first dimension across the one or more core clusters and a second dimension across a physical layout of the plurality of cores.
